(19) United States
(12) Patent Application Publication
(10) Pub. No.: US 2025/0316858 A1
(43) Pub. Date: Oct. 9, 2025

(54) BATTERY CELL WITH TAB ANCHOR

(71) Applicant: Ford Global Technologies, LLC, Dearborn, MI (US)

(72) Inventors: Daewon HAN, New Hudson, MI (US); Myoungshin HONG, Ann Arbor, MI (US); Chi PAIK, Grosse Ile, MI (US)

(73) Assignee: Ford Global Technologies, LLC, Dearborn, MI (US)

(21) Appl. No.: 18/627,064

(22) Filed: Apr. 4, 2024

(51) Int. Cl. H01M 50/533; H01M 50/105; H01M 50/178; H01M 50/186; H01M 50/193; H01M 50/534; H01M 50/536; H01M 50/562

(52) U.S. Cl. CPC H01M 50/533; H01M 50/105; H01M 50/178; H01M 50/186; H01M 50/193; H01M 50/534; H01M 50/536; H01M 50/562

(57) ABSTRACT

A pouch-type battery cell includes metal tabs that extend outside the sealed envelope. To increase seal durability around these tabs, polymer anchors are formed through anchor holes in the tabs during the fabrication process of the tab assemblies. Manufacturing of such tabs can include placing polymer tab films on each side of an electrically conductive tab, the electrically conductive tab having at least one anchor hole, and heating the electrically conductive tab and the polymer tab films causing the polymer tab films to bond to one another through the at least one anchor hole to form at least one anchor.

### TECHNICAL FIELD

The present disclosure relates to a battery, such as a battery for an electrified vehicle. More particularly, the disclosure relates to a pouch-type battery cell having a tab assembly with a film layer mechanically anchored to the tab through holes in the tab.

### BACKGROUND

An electrified vehicle uses electric power stored in a battery for propulsion instead of or in addition to an internal combustion engine. Some electrified vehicles utilize a battery having pouch type battery cells in which the electrode assembly is enclosed between a lower film and an upper film. The two films are thermally bonded to one another to form a seal. The maximum allowable internal pressure is limited by the weakest region of the seal, which tends to be the region surrounding the tabs.

### SUMMARY

A pouch battery cell includes an electrode stack, positive and negative tabs, upper and lower pouch films, and a polymer. The electrode stack having an anode, a cathode, and a separator. The positive tab is electrically connected to the cathode while the negative tab is electrically connected to the anode. These connections may be made, for example, by welding. The positive tab defines at least one first anchor hole while the negative tab defines at least one second anchor hole. The positive tab may be made of aluminum. The negative tab may be made of copper. The upper and lower pouch films are on opposite sides of the electrode stack. The positive tab and the negative tab project beyond edges of the pouch films. The upper and lower films may also be adhered to one another to create a sealed envelope surrounding the electrode stack and containing an electrolyte. The polymer is adhered to inner surfaces of the upper and lower pouch films. The polymer has anchors extending through the at least one first anchor hole and the at least one second anchor hole. The polymer may be a thermoplastic polymer such as polypropylene.

A tab assembly for a battery cell includes an electrically conductive tab and a polymer. The electrically conductive tab defines at least one anchor hole extending from a first surface to a second surface. The tab may be made of aluminum or copper. The polymer is adhered to the first surface and the second surface and includes at least one anchor extending through the at least one anchor hole. The polymer may be a thermoplastic polymer such as polypropylene. The tab protrudes from the polymer in two directions.

A process for fabricating a tab assembly for a pouch battery cell includes placing polymer tab films on each side of an electrically conductive tab and applying heat. The tab has at least one anchor hole. At least one of the polymer tab films may have at least one protrusion which extends into the at least one anchor hole. The heating causes the polymer films to bond to one another through the at least one anchor hole to form at least one anchor. The heating may also cause the polymer films to bond to the tab and to bond to one another around two edges of the tab. Pressure may also be applied. A process for fabricating a pouch battery cell includes fabricating two tab assemblies as indicated, welding them to the anode and cathode of an electrode stack, respectively, and sealing the electrode stack between upper and lower pouch films. The tabs extend beyond edges of the pouch films.

### BRIEF DESCRIPTION OF THE DRAWINGS

FIG. 1 is a block diagram of a battery for an electrified vehicle.

FIG. 2 is a top view of tab blank at a stage of the tab assembly fabrication process.

FIG. 3 is an illustration of a stage of the tab assembly fabrication process.

FIG. 4 is a top view of the completed tab assembly.

FIG. 5 is a cross-sectional view through the completed tab assembly of FIG. 4.

FIG. 6 is a top view of an electrode stack assembly at a stage of fabrication of the pouch-type battery cell.

FIG. 7 if a cross sectional view of a film.

FIG. 8 is a top view of a pouch-type battery cell.

FIG. 9 is a flow chart of the fabrication process for the pouch-type battery cell of FIG. 8.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Pouch battery cells, also known as soft-pack batteries, are a type of lithium-ion battery that is distinguished by its flexible packaging. Unlike the more rigid cylindrical and prismatic cell formats, pouch cells encase the battery material in, for example, a flexible, laminated aluminum foil or similar material. This packaging approach may, in certain circumstances, offer benefits including higher energy density, flexibility in size and shape, and a lighter weight.

The construction of certain pouch battery cells involves several components and materials, organized in a layered structure. The two primary electrodes in a pouch cell are the cathode (positive electrode) and anode (negative electrode). These electrodes are made from different materials that allow lithium ions to move in and out during charging and discharging. Common materials include lithium cobalt oxide (LiCoO2) or lithium iron phosphate (LiFePO4) for the cathode and graphite for the anode. Between the cathode and anode lies a porous separator, which allows lithium ions to pass through while electrically isolating the electrodes from each other to prevent short-circuiting. The separator is typically made from a polyethylene or polypropylene film. The electrolyte may be a lithium salt solution in an organic solvent that facilitates the movement of lithium ions between the cathode and anode during battery operation. It fills the space within the cell, saturating the electrodes and separator.

A feature of pouch cells is their packaging, which in some arrangements uses a flexible, multilayer laminate that includes aluminum foil sandwiched between polymer layers. This packaging is heat-sealed to create a lightweight, leak-proof enclosure for the cell components. The flexible nature of the packaging allows for use of space and can accommodate cell swelling during charge and discharge cycles. Electrical tabs are attached to the electrodes to provide external electrical connections. These tabs are welded to the current collectors of the cathode and anode and extend outside the pouch for connection to the battery management system and other cells.

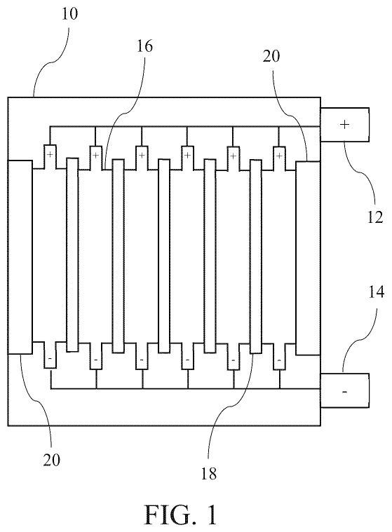

Referring to FIG. 1, a battery 10, such as a traction battery for an electrified vehicle, provides an electrical potential (voltage) between a positive terminal 12 and a negative terminal 14. The battery includes a stack of battery cells 16. The illustrated embodiment includes six cells, but the number may vary. Each cell includes an anode, a cathode, and a separator. Each cell also has a positive tab electrically connected to the cathode and a negative tab electrically connected to the anode. In the illustrated embodiment, the cells are connected in parallel. In other words, the positive tabs are electrically connected to the positive terminal 12 and the negative tabs are electrically connected to the negative terminal 14 of the battery such that the voltage of the battery is equal to the voltage provided by each cell. In other embodiments, some cells may be connected to one another in series such that the voltage of the battery exceeds the voltage of individual cells. An insulator or heat sink 18 may be inserted between adjacent cells. Pressure plates 20 on each end of the stack of cells are arranged to compress the cells together.

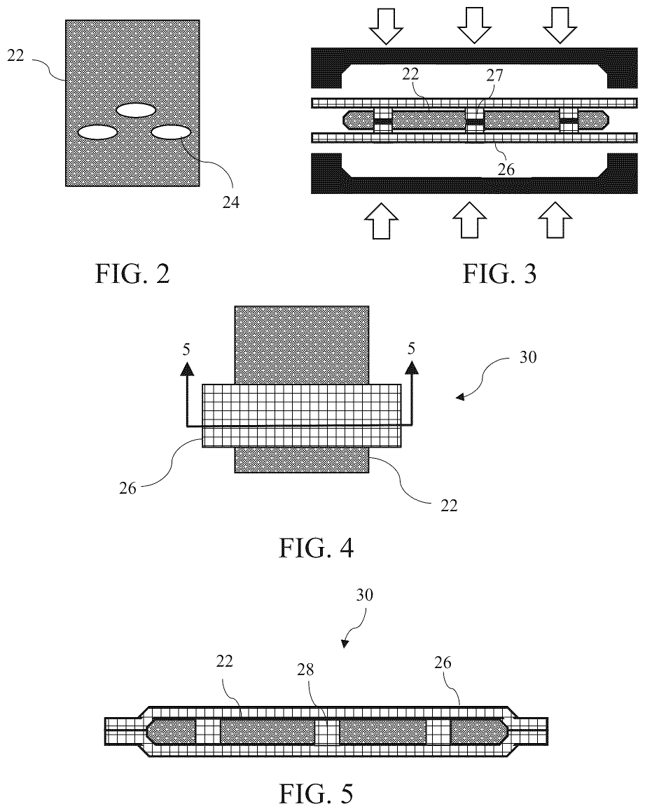

FIGS. 2-5 illustrate a fabrication process for tab assemblies for pouch battery cells. FIG. 2 illustrates a tab 22 at a stage of the fabrication process. The tab 22 is made of an electrically conductive material, such as aluminum or copper. The tab includes a set of anchor holes 24. In the illustrated embodiment, there are three oval shaped anchor holes, but the number, shape, size, and arrangement of anchor holes may vary. FIG. 3 is a cross section illustrating a stage of the tab assembly fabrication process. Tab films 26 are placed on the surfaces of the tab 22. The tab films are made of thermoplastic polymer such as polypropylene (PP). Each tab film 26 has protrusions 27 that extend into the anchor holes 24. Pressure and heat are applied, causing the tab films 26 to bond to one another and to the tab 22. The protrusions also bond to one another through the anchor holes, forming anchors 28. These anchors assist in holding the tab films firmly in place with respect to the tabs 22. FIG. 4 illustrates the completed tab assembly 30. The tab film 30 covers the region of the tab 22 that includes the anchor holes, but the tab extends beyond the tab film in two directions. FIG. 5 is a cross-sectional view of the completed tab assembly 30, illustrating how the anchors 28 mechanically connect the two tab films 26 to one another.

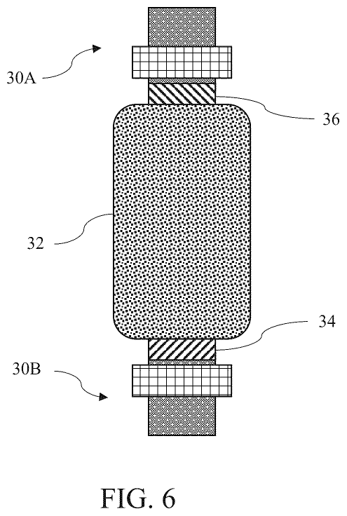

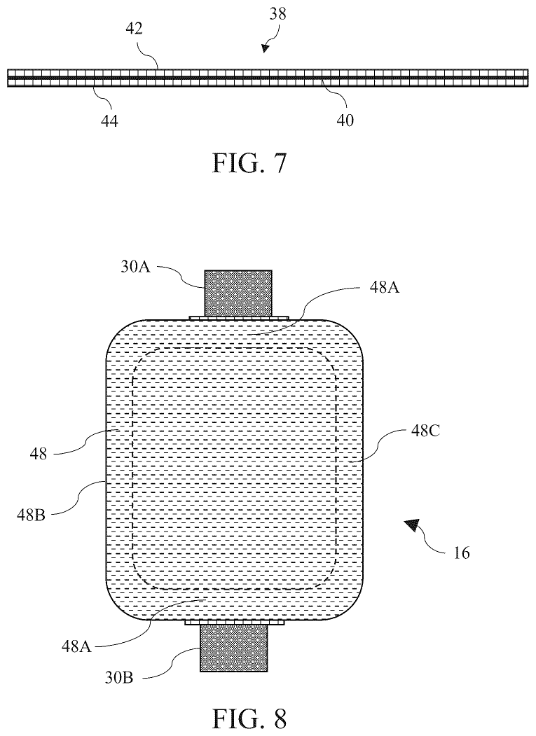

FIGS. 6-8 illustrate a fabrication process for pouch battery cells utilizing the tab assemblies as described above. At the stage illustrated in FIG. 6, two tab assemblies 30A and 30B have been welded to an electrode stack 32. The electrode stack includes an anode 34, a cathode 36, and a separator. A positive tab assembly 30A is welded to the cathode 36. The tab of tab assembly 30A may be aluminum. A negative tab assembly 30B is welded to the anode 34. The tab of tab assembly 30B may be copper. The electrode stack is enclosed between two sheets of pouch film 38 which may be referred to herein as the lower film 38A and the upper film 38B, although the orientation is not significant. FIG. 7 is a cross-section of the pouch film. The pouch film 38 includes a foil layer 40 which may be, for example, aluminum. The inner surface is coated with a thermoplastic polymer layer such as polypropylene (PP and/or PPa). The outer surface is coated with an insulation layer which may be, for example, polyethylene terephthalate (PET), nylon, or other material. FIG. 8 illustrates the completed pouch-type battery cell 16. A seal 48 is formed around a periphery of the lower film and the upper film by applying heat which causes the polymer inner layers to bond with one another. In the vicinity of the terminals, the polymer inner layers bonds with the tab films 26. The seal may be formed in sections. Section 48A around the tabs may be formed first. Then, section 48B may be formed. Finally, section 48C may be formed after filling the pouch with electrolyte.

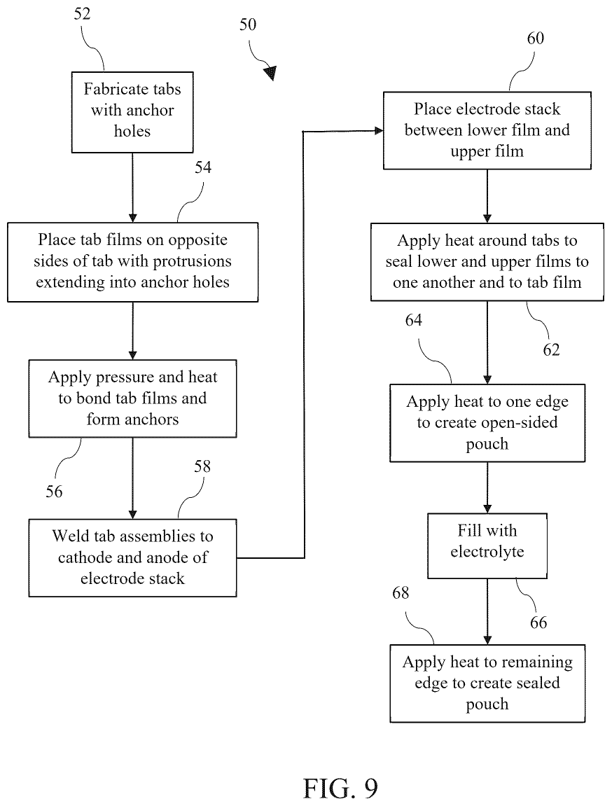

FIG. 9 is a flow-chart for the fabrication process 50. Some steps may be performed in a different order than indicated. At 52, the tab blank as shown in FIG. 2 is fabricated. The number, shape, size, and arrangement of anchor holes may vary as long as they provide sufficient anchoring area and the remaining metal is sufficient to conduct the electrical current without excessive resistance. At 54, the tab films are positioned relative to the tab blanks with protrusion extending into the anchor holes. At 56, heat and pressure are applied as shown in FIG. 3. The tab films bond to one another and to the tab blank and the anchors are formed as the protrusions bond to one another. At 58, the tab assemblies, as shown in FIGS. 4 and 5, are welded to the anode and cathode of the electrode stack as shown in FIG. 6. At 60, the electrode stack, with the tabs welded in place, is positioned between two pouch films. The tabs protrude beyond edges of the pouch films. In an alternative embodiment, a single sheet of film material may be folded to form the upper and lower pouch films. At 62, heat is applied along the edges from which the tabs extend to form seal 48A. The inner layer of each pouch film bonds to the tab film. Away from the tab, the inner layers of the pouch films bond to one another. At 64, heat is applied along one edge to form seal 48B. In the alternative embodiment using a folded film, this step may not be required because the upper and lower films are joined at the fold line. After step 64, the pouch is open on only one side and is capable of containing a liquid as long as the open side is at the top. At 66, the pouch is filled with an electrolyte. At 66, heat is applied to the remaining edge to form seal 48C. After step 68, the pouch is completely sealed and contains the electrolyte in any orientation, even under pressure.

While exemplary embodiments are described above, it is not intended that these embodiments describe all possible forms encompassed by the claims. Other topologies and variations are, of course, contemplated.

The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A pouch battery cell comprising:
an electrode stack having an anode, a cathode, and a separator;
a positive tab electrically connected to the cathode, the positive tab defining at least one first anchor hole;
a negative tab electrically connected to the anode, the negative tab defining at least one second anchor hole;
upper and lower pouch films on opposite sides of the electrode stack, the positive tab and the negative tab projecting beyond edges of the upper and lower pouch films; and
a polymer adhered to inner surfaces of the upper and lower pouch films, the polymer having anchors extending through the at least one first anchor hole and the at least one second anchor hole.

2. The pouch battery cell of claim 1 wherein the upper and lower pouch films are adhered to one another to create a sealed envelope surrounding the electrode stack.

3. The pouch battery cell of claim 2 further comprising an electrolyte contained within the sealed envelope.

4. The pouch battery cell of claim 1 wherein the positive tab is made of aluminum.

5. The pouch battery cell of claim 1 wherein the negative tab is made of copper.

6. The pouch battery cell of claim 1 wherein
the negative tab is welded to the anode; and
the positive tab is welded to the cathode.

7. The pouch battery cell of claim 1 wherein the polymer is a thermoplastic polymer.

8. The pouch battery cell of claim 1 wherein the polymer is polypropylene.

9. A tab assembly for a battery cell, the tab assembly comprising:
an electrically conductive tab defining at least one anchor hole extending from a first surface to a second surface; and
a polymer adhered to the first surface and the second surface and including at least one anchor extending through the at least one anchor hole; wherein
the electrically conductive tab protrudes from the polymer in two directions.

10. The tab assembly of claim 9 wherein the polymer is a thermoplastic polymer.

11. The tab assembly of claim 9 wherein the polymer is polypropylene.

12. The tab assembly of claim 9 wherein the electrically conductive tab is made of aluminum.

13. The tab assembly claim 9 wherein the electrically conductive tab is made of copper.

14. A process for fabricating a tab assembly for a pouch battery cell, the process comprising:
placing polymer tab films on each side of an electrically conductive tab, the electrically conductive tab having at least one anchor hole; and
heating the electrically conductive tab and the polymer tab films causing the polymer tab films to bond to one another through the at least one anchor hole to form at least one anchor.

15. The process of claim 14 further comprising applying pressure to the electrically conductive tab and the polymer tab films during the heating.

16. The process of claim 14 wherein at least one of the polymer tab films has at least one protrusion which extends into the at least one anchor hole before the heating.

17. The process of claim 14 wherein heating the electrically conductive tab and the polymer tab films also causes the polymer tab films to bond to the electrically conductive tab and to bond to one another around two edges of the electrically conductive tab.

18. A process for fabricating a pouch battery cell comprising:
fabricating first and second tab assemblies according to the process of claim 14;
welding the first tab assembly to an anode of an electrode stack;
welding the second tab assembly to a cathode of the electrode stack;
placing upper and lower pouch films on opposite sides of the electrode stack such that the first and second tab assemblies extend beyond edges of the upper and lower pouch films; and
applying heat to adhere the upper and lower pouch films to one another and to the polymer tab films of the first and second tab assemblies to form a sealed envelope.
